(19) United States
(12) Patent Application Publication
(10) Pub. No.: US 2008/0121187 A1
(43) Pub. Date: May 29, 2008

(54) METHOD OF WASHING GRAIN-BASED SUBSTRATE AND ANIMAL LITTER PREPARED USING SUCH SUBSTRATE

(75) Inventor: Roger E. McPherson, Muscatine, IA (US)

Correspondence Address: BANNER & WITCOFF, LTD., TEN SOUTH WACKER DRIVE, SUITE 3000, CHICAGO, IL, 60606, US

(73) Assignee: Grain Processing Corporation, Muscatine, IA (US)

(21) Appl. No.: 11/469,174

(22) Filed: Aug. 31, 2006

(51) Int. Cl. B08B 3/00; A01K 29/00

(52) U.S. Cl. 119/171; 422/5

(57) ABSTRACT

Disclosed is a method of washing a grain-based substrate, such as a spent grain germ. The grain-based substrate is contacted with steam and maintained in contact with steam for a time and at a pressure sufficient to liberate at least a portion of one odor component present in the substrate. Subsequently, at least a portion of the steam and at least some of the liberated odor component is separated from the balance of the substrate, thereby leaving a washed substrate. An additive, such as a soap or detergent, may be used in connection with the washing step. The grain-based substrate may be used in connection with an animal litter. In one embodiment, a litter is prepared from distiller's dried grain. Surprisingly, washing of the dried grains in accordance with the preferred teachings reduces the odor of the distiller's dried grains and yields a litter with excellent clumping properties.

### TECHNICAL FIELD OF THE INVENTION

The invention is in the field of washing of substrates. In some embodiments, the invention is in the field of animal litters and methods for preparing animal litters.

### BACKGROUND OF THE INVENTION

Numerous animal litters have been described in the prior art. Conventionally, an animal litter is an absorbent substance, such as a mineral clay, that is placed into a container or other location at which the material is accessible to an animal. Perhaps the most familiar example of an animal litter is conventional clay-based cat litter.

In recent years, efforts have been made to develop animal litters that are not based on mineral clays. Such litters can offer a number of advantages over clay-based litters; for instance, in many embodiments, litters based on organic materials may be flushed into a sewer or septic system after use by a household animal. The assignee of the present application, Grain Processing Corporation of Muscatine, Iowa, has devised a number of organic animal litters, many of which are based on spent corn germ and other corn-based substrates. Examples of such litters are described in U.S. Pat. Nos. 6,868,802; 6,622,658; 6,405,677; 6,216,634; and 6,098,569. The teachings of each of the foregoing patents, as they pertain to animal litters, methods of preparing animal litters, and methods of removal of animal waste, are hereby incorporated by reference in their entireties. In connection with the practice of litters of at least of some of the foregoing patents, it is preferred to provide a litter that is composed at least in part of a washed, spent grain germ, in particular washed, spent corn germ. Where the germ is produced in connection with a wet corn milling process, the germ is washed to reduce the level of odor components present in the germ to thereby render the germ and the resulting litter less odorous and therefore more palatable to a homeowner.

Numerous methods for washing grain germ and other grain-based substrates are known. Conventionally, grain germ is washed by a countercurrent washing procedure that involves use of sequential hydroclones. In practice, the assignee of the present application has found that such washing is suitable to produce grain germ that is commercially acceptable for use in an animal litter. In general, over 25 lbs. of dilute waste water is generated in the production of 1 lb. of washed, expeller-extracted spent germ.

Conventionally, commercial distilleries produce ethanol from the fermentation of an aqueous mixture of a grain, typically corn. The residue remaining after distillation and drying of the slurry is known as distiller's dried grains. Commercially, soluble components of the distiller's dried grains are not separated from insoluble portions, and the commercial product, distiller's dried grain with solubles, is used in animal feeds. Recently, an increase in oil prices has led to an increase in the production of ethanol, and a corresponding increase in the production of distiller's dried grains. Distiller's dried grains generally are unsatisfactory in animal litter, because they have a strong odor that is objectionable. Also, it is difficult to produce a clumping animal litter with a distiller's dried grains substrate.

In preferred embodiments, the invention seeks to provide a method of washing a grain germ or other grain-based substrates that is different from the method heretofore described. In highly preferred embodiments, the invention seeks to provide a method for washing a grain-based substrate in which relatively smaller amounts of water may be used.

### SUMMARY OF THE INVENTION

It has now been found that a grain-based substrate may be contacted with steam and maintained in contact with steam for a time and at a pressure sufficient to liberate at least a portion of one odor component from substrate. Subsequently, at least a portion of the steam and at least some of the liberated odor component may be separated from the balance of the grain-based substrate, thereby leaving washed grain-based substrate. The grain-based substrate in some embodiments comprises spent grain germ, such as spent corn germ. In preferred embodiments, the method includes jet cooking the substrate in a jet cooking apparatus, and flashing steam after the substrate has been maintained in contact with the steam. If desired, an odor-mitigating additive may be added during the washing step.

The invention also encompasses a method for preparing an animal litter. In the preferred embodiments, the method for preparing the animal litter includes providing a washed, spent grain-based substrate, such as spent grain germ, the germ or other substrate having been washed by contacting the germ with steam as described hereinabove, and forming discrete plural compacted particles which comprise the grain-based substrate. Other materials may be incorporated in the litter, such as a cohesiveness agent or supplemental cohesiveness agent.

Also encompassed by the invention is an animal litter. In preferred embodiments, the animal litter includes a washed, spent grain-based substrate, such as grain germ, the substrate having been washed as described hereinabove and being in the form of discrete plural compacted particles.

In some embodiments of the invention, the grain-based substrate is a distiller's dried grain substrate. It has been found that upon washing of the distiller's dried grain as described herein, and preferably upon dewatering of the washed grain, the substrate, in preferred embodiments, will have an odor that is acceptable for use in an animal litter. Surprisingly, the distiller's dried grain prepared in accordance with the preferred embodiments of the invention is useful in conjunction with a clumping animal litter.

Further details concerning the preferred embodiments are set forth hereinbelow.

### DETAILED DESCRIPTION OF THE PREFERRED EMBODIMENTS

The invention is deemed applicable to the washing of any grain-based substrate. The grain-based substrate may comprise or be derived from any suitable grain, such as corn, wheat, soy, sorghum, alfalfa, barley, rice, and so forth. Moreover, any suitable whole grain or grain fraction thereof may be washed in conjunction with the invention. When the substrate is to be used in conjunction with an animal litter, preferably a liquid-absorbent portion of the substrate is employed. In some highly preferred embodiments of the invention, the substrate is a grain germ, most preferably spent corn germ. Spent corn germ from a wet corn milling process may be used. In other preferred embodiments, the substrate is distiller's dried grain. As used herein, distiller's dried grain encompasses either distiller's dried grain with solubles or distiller's dried grain from which soluble components have been removed. The terms “dried grain” and “dried grains” are used interchangeably herein, and reference to dried “grains” does not signify that plural types of grain are required (although plural grains may be used). In commercial practice, distiller's dried grain with solubles is preferred, because it is less expensive than distiller's dried grains from which solubles have been separated, and is readily commercially available. The choice of substrate to be washed is a matter within the purview of one of ordinary skill in the art and may depend on the specific application for the washed substrate.

The substrate is brought into contact with and maintained in contact with steam for a time and at a temperature and pressure sufficient to cause at least one odor component to become wholly or partially liberated from the substrate. Preferably, the steam is applied at positive gauge pressure. The precise chemical nature of the odor component or components that are liberated is not critical, nor is the manner in which the odor component or components are liberated. So long as the odor of the substrate is reduced, mitigated, or modified upon washing, the method of this aspect of the invention is deemed satisfied. The evaluation of odor before and after washing can be evaluated by any suitable methodology, such as presenting samples of the substrate before and after washing to a panel of human evaluators. Although it is not intended to limit the invention to a particular theory of operation, is believed that odor components are liberated in many cases in part because of the increased solubility or volatility of such components at the elevated temperatures encountered upon contact with steam, particularly at positive gauge pressures. The odor components also may be modified by the steam and/or additives to the steam, as discussed in more detail hereinbelow.

Any suitable apparatus may be employed in contacting the substrate with steam and maintaining the substrate in contact with steam. In preferred embodiments, the apparatus is a jet cooking apparatus. As is known to persons of skill in the art, a jet cooking apparatus resembles a jet pump that is employed to move liquids and slurries. In a jet cooking process, high pressure saturated steam, at a positive gauge pressure that usually ranges from about 60 to about 200 psig, is injected through a nozzle into the center of a venturi mix combining tube. The steam is pulled into the annular gap formed by the steam nozzle and the venturi opening. The slurry of steam and substrate is heated as it accelerates to sonic velocity within the mixing tube. Such an apparatus, or similar apparatus, is preferred for use in conjunction with the invention, although any other suitable apparatus may be employed.

Any suitable conditions may be employed in connection with the jet cooking of the substrate. For instance, the solids content within the cooking apparatus may have any suitable value, such as a value ranging 2% to 20%, or, more preferably, 5% to 10%. The pressure within the jet cooking apparatus may range from 60 to 200 psig, more preferably 65 to 75 psig, although any suitable pressure may be employed. For instance, the pressure may be 10 psig or greater, 20 psig or greater, 30 psig or greater, 40 psig or greater, 50 psig or greater, or any other suitable value. Likewise, the residence time of the substrate in the cooker may have any suitable value. A suitable range is 1-25 minutes, preferably 3-5 minutes, but, more generally, the residence time may be at least 10 seconds, at least 20 seconds, at least 30 seconds, at least 40 seconds, at least 50 seconds, at least 60 seconds, at least 70 seconds, at least 80 seconds, at least 90 seconds, at least 100 seconds, at least 110 seconds, at least 120 seconds, at least 3 minutes, at least 4 minutes, or any other suitable value. Likewise, the temperature within the jet cooking apparatus may have any suitable value. Any temperature that is sufficient to form steam is suitable and thus, for instance, the temperature may be at least 220° F., 230° F., 240° F., 250° F., 260° F., 270° F., 280° F., 290° F., 300° F., or, more generally, any suitable value. One preferred range is 300° to 400° F. Any operable combination of the forgoing conditions, or more generally, any other conditions that are operable may be employed in conjunction with the practice of the invention.

When employed under operating conditions that are presently deemed preferred with the equipment employed by the assignee of the present application, as described in one of the following examples, the amount of waste water generated will be about 11.5 lbs. per lb. of weighed substrate. This represents substantially less water than heretofore used in the washing of spent corn germ in connection with the preparation of animal litters.

If desired, an odor mitigating additive may be used in conjunction with the washing step. Generally, the additive may be any material that assists in liberation of the odor components, for instance, by solubilizing of the odor component or by reaction of the odor component. For instance, the additive may be a detergent, soap, or other surfactant, or an oxidant such as sodium hypochlorite, or a deodorizer such as citric acid or sodium bicarbonate, or a reducing agent.

Various mechanisms or combinations of mechanisms may be responsible for the reduction of odors by the jet-cooking of grain-based substrates. Without limiting the invention to a particular theory of operation, it is believed that the increased solvency of water at the temperatures of jet cooking may contribute to the removal of odors or components that generate odors. The additives that may be employed may cause degradation or other reaction of odor components to form materials with a non-offensive or different odor, or to form a material that is more easily removed. For instance, surfactants are believed to operate by increasing the solubility of certain components into the hot waste water. Oxidizing agents are believed to function by converting certain components into either more soluble or more volatile materials. Reducing agents may operate by inhibiting the formation of oxidization products, particularly when the substrate material contains oils. Acids are believed to increase the solubility of certain components, such as amines, and to increase the volatility of other components, such as thiols. Alkaline agents are believed to increase the solubility of certain components such as organic acids and to increase the volatility of other components such as amines.

It is believed in many cases that the dewatering of the washed substrate also may have an effect on the odor of the substrate. Some of the odor components in the substrate may become partially or completely solubilized in the washing step, and the dewatering of the substrate may cause separation of these components from the balance of the substrate. In addition, particularly when the substrate contains oil, the oil may be caused to be less viscous during the washing step, particularly in light of the temperatures employed in the preferred embodiments of the invention. Dewatering may cause separation of some of the oil in the original substrate from the balance of the substrate. Particularly when the substrate is distiller's dried grain, it is believed that this phenomenon accounts for removal of some of the oil originally present in the grain.

When used, the additive may be added in any suitable amount, preferably in an amount ranging from 0.1% to 10% by dry basis weight of the substrate, more preferably, 0.1% to 5%, and even more preferably 1% to 2%. Combination of additives may be employed; when such are employed, the total amount of such additives preferably is within the range stated hereinabove. The choice of additive for a particular substrate and the selection of an amount of additive are matters within the purview of one skilled in the art.

After maintenance in the cooking tube of the jet cooking apparatus for the desired length of time, steam is preferably flashed off, thereby leaving a washed substrate. If an apparatus other than a jet cooking apparatus is employed in conjunction with the practice of the washing step, any other suitable procedure for separating steam from the balance of the substrate may be employed. It is contemplated that at least some of the odor component or components that are liberated from the substrate will be thereby separated from the balance of the substrate, leaving a substrate that has an odor that is different from the odor of the substrate prior to washing.

Subsequently, the substrate may be de-watered. Any suitable de-watering method, such as filtering or centrifugation, may be employed to de-water the substrate. Dewatering may cause odor components, or other materials, such as oils (which may or may not have odor) to become separated from the balance of the substrate. The de-watered material then may be dried by any suitable technique.

The washed substrate may be used in conjunction with an animal litter, as taught in the heretofore referenced Grain Processing Corporation patents. For instance, as taught therein, discrete plural particles in the form of compressed or compacted particles may be provided via an operation such as a pelletizing, extrusion, or the like. In one embodiment, the particles are prepared by pelletizing the washed grain-based substrate in a pellet mill. The pellets prepared thereby are ground or crumbled, where necessary, to a size suitable for use as an animal litter. Preferably the animal litter is in the form of granules or particles having a size ranging from about 4 to about 400 mesh (USS); more preferably, about 8 to about 80 mesh; and most preferably about 14 to about 20 mesh. Use of a lubricity agent such as corn oil in the pelletizing process may be desirable.

The compressed particles thus formed may be sufficiently cohesive for use in animal litter. Preferably, however, the granules include a cohesiveness agent to enhance the cohesiveness of the animal litter granules. The cohesiveness agent is believed to provide additional hydroxyl groups, which enhance the bonding between grain proteins within the litter particles. It is further believed that the additional hydroxyl groups so function by enhancing the hydrogen bonding of proteins to starch and to other proteins. The cohesiveness agent may be present in any amount suitable to enhance the cohesiveness of the animal litter particles.

The cohesiveness agent preferably is a polysaccharide. Any polysaccharide may be used in conjunction with the invention and thus, for instance, the cohesiveness agent may comprise one or more polysaccharides such as dextrins, maltodextrins, starches, flours, cellulosics, hemicellulosics, and the like. Preferably, the cohesiveness agent comprises a starch, and most preferably, the cohesiveness agent comprises a corn starch.

Some prior art litters employ modified, pre-gelatinized starches to effect adhesion between particles of litter, i.e., interparticle adhesion. The starch used in conjunction with the litters of the present invention is not used specifically for this purpose, but rather is employed to effect intraparticle cohesion. In many embodiments of the invention, a clumping animal litter will be prepared, as described in more detail in the heretofore enumerated Grain Processing Corporation patents. The clumping interparticle agglomeration of the animal litter of the invention is believed to result primarily as a result of the interaction of proteins or other components present by virtue of the grain-based substrate, and is not believed to result from adhesion forces generated through the use of starch. It has been found that non-gelatinized, unmodified starches are especially suitable for use as cohesiveness agents in conjunction with the invention. When unmodified starches are employed, it is believed that such starches may contribute to a small extent to interparticle adhesion in the clumped litter.

The clumping litters of the invention preferably further include a supplemental cohesiveness agent. In accordance with the invention, the supplemental cohesiveness agent is an ionic species that is believed to enhance protein-protein and/or protein-starch interactions. Any suitable ionic species, typically an ionic salt, may be used in conjunction with the invention. For example, in accordance with preferred embodiments of the invention, the supplemental cohesiveness agent is selected from among the alkali and alkaline-earth salts of common anions, such as the halide, nitrate, nitrite, carbonate, phosphate, sulfate, and bicarbonate salts, and the like. More preferably, the supplemental cohesiveness agent is selected from the group consisting of sodium chloride, calcium chloride, sodium carbonate, calcium carbonate, sodium bicarbonate and mixtures thereof. Even more preferably, the supplemental cohesiveness agent is selected from among sodium chloride, calcium carbonate, and mixtures thereof. Most preferably, the supplemental cohesiveness agent is sodium chloride. The supplemental cohesiveness agent may be present in any amount sufficient to assist the cohesiveness agent in enhancing the cohesion of the animal litter granules.

Because the animal litter of the invention is made from biodegradable materials, the litter is subject to spoilage, such as by molding. To prevent or inhibit such molding, the litter may include a mold inhibitor, which may be present in any amount sufficient to inhibit the molding of the animal litter. Any suitable mold inhibitor may be employed in conjunction with the invention. The mold inhibitor preferably is selected from among the propionate salts, and most preferably is selected from the group consisting of sodium propionate and calcium propionate.

The animal litter of the invention may comprise the washed, grain-based substrate alone, or in conjunction with other ingredients. In some embodiments, the washed grain-based substrate is present in a dry basis amount of at least about 45% by weight of the animal litter (based on the total weight of the animal litter including moisture). In such embodiments, the grain-based substrate may be present in an amount ranging from about 50% to about 85% by weight, such an amount ranging from about 60% to about 75% by weight; in some cases 67.5% by weight. In other embodiments, the substrate is present in an amount ranging from 20-25% by weight. The remaining dry components of the animal litter preferably include the cohesiveness agent, and, when used, a supplemental cohesiveness agent. The cohesiveness agent may be present in a dry basis amount ranging up to about 45% by weight of the animal litter; in some cases, an amount ranging from about 3% to about 35% by weight; in some cases, an amount ranging from about 10% to about 25% by weight; and in some cases, inclusive of the supplemental cohesiveness agent, an amount of about 18% by weight, of which about 16.2% by weight comprises the cohesiveness agent.

The supplemental cohesiveness agent, when used, is preferably present in an amount of at least about 0.05% be weight, exclusive of the polysaccharide cohesiveness agent. More preferably, the supplemental cohesiveness agent is present in an amount ranging from about 0.05% to about 8% by weight; more preferably, about 0.1% to about 6% by weight; and most preferably, about 1.5% to about 4% by weight. When a mold inhibitor is employed, it preferably is present in an amount ranging from about 0.02% to about 3.5% by weight.

To maintain the cohesiveness and sorption capacity of the animal litter, the litter preferably has a moisture content sufficiently high to prevent the granules of animal litter from becoming friable and sufficiently low to allow additional moisture to be absorbed. Preferably, the moisture content is less than about 30%. More preferably, the moisture content ranges from about 5% to about 25%; even more preferably, the moisture content ranges from about 10% to about 20%; even more preferably, the moisture content ranges from about 12% to about 16%, and most preferably the moisture content is about 14.5%. It is contemplated that some of the moisture in the animal litter will be present originally in the grain-based substrate and/or cohesiveness agent.

The animal litter will be effective in suppressing odors of animal waste. Animal urine contains urea, a compound which breaks down in animal litterboxes to form ammonia. The ammonia odor of animal litterboxes is often considered to be objectionable. Animal litters made in accordance with the preferred embodiments of the invention will be effective in masking ammonia odors.

The litter of the invention preferably has a density sufficient to allow interparticle binding, yet that will minimize the weight of litter in a litterbox. In accordance with the invention, the litter preferably has a density ranging from about 15 to about 45 lbs./cu.ft. More preferably, the density of the animal litter ranges from about 25 to about 40 lbs./cu.ft.; and even more preferably, the density is in the range of from about 30 to about 35 lbs./cu.ft. Density preferably is evaluated after loosely filling a container and measuring the weight of a specific volume of the litter.

Because the animal litter of the invention is to be used to absorb animal waste, the litter should have a sorption capacity sufficient to allow the animal litter to so function. The sorption capacity of the preferred litters of the invention typically is at least about 0.04 ml water per gram of litter, and more typically ranges from about 0.04 to about 2.4 ml/g; more typically, the sorption capacity is from about 1.0 to about 1.4 ml/g. The sorption capacity is determined per gram of animal litter, and is based on the sorption of deionized water, as described in more detail in the heretofore enumerated Grain Processing Corporation patents. Preferred sorption capacity ranges are believed to approximate that of animal urine.

Other properties may be desired of an animal litter. For example, to minimize inconvenience and mess associated with packaging, transporting, and using the litter, the litter preferably generates a minimal amount of dust. The preferred litters of the present invention do not generate substantial dust. Another preferred property is clumping efficiency. Clumping efficiency is the amount of litter required to form a clump with a given volume of liquid, with lower amounts of required litter corresponding to higher clumping efficiencies. Preferably, to absorb 150 ml animal urine, less than about 120 g of litter is required; more preferably, less than about 110 g is required.

Other desired properties include biodegradability and tendency to remain clumped. Biodegradability is particularly desired when the animal owner wishes to dispose of clumps of litter by flushing them into the toilet. The litter of the preferred embodiments of the invention is biodegradable, and thus may be disposed of by flushing, even into a septic system. Tendency to remain clumped refers to the stability of the clump of clumped litter. The preferred litters of the invention are clumping litters.

The invention is also directed towards a process for preparing an animal litter. In accordance with the invention, the process comprises the step of providing discrete plural particles of a grain-based substrate in a particle size suitable for use as an animal litter, as previously described. Preferably, the process includes a step of compacting or compressing the substrate, which most preferably is accomplished in a pelletizing step. The mold inhibitor and cohesiveness agent, when used, can be added at any suitable time, and preferably are mixed with the grain-based substrate in the desired proportions prior to pelletizing of the grain-based substrate. Moisture content in the pellet mill feed preferably is in the ranges set forth above with respect to the moisture content in the finished product, and preferably is about 14-14.5%. Preferably, moisture is added to the feedstock in the form of liquid water to bring the feedstock to this moisture content. The temperature in the pellet mill preferably is brought to about 82° C. with steam. The pellet mill may be operated under any conditions that impart sufficient work to the feedstock to provide pellets. In one preferred embodiment, the pellet mill is operated with a suitably sized die, such as a ⅛ in.×2 in. die at 100 lb./min. at 82° C. to provide pellets, which then are crumbled in a pellet crumbler to provide discrete plural particles having a particle size capable of passing through an 8 mesh screen but being retained on a 20 mesh screen.

Also encompassed by the invention is a method for the removal of animal waste. The method comprises the steps of allowing an animal to excrete waste into the animal litter, whereby the litter agglomerates into at least one clump, and removing the soiled litter and any solid waste leaving behind substantially unspoiled litter. The litter may be provided in a container, by which is contemplated any enclosed or partially enclosed area, such as a litterbox, a cage, a stall, a pen, or the like. The method is contemplated to be useful for any animals, such as cats, dogs, mice, birds, gerbils, and other animals, and finds particular applicability in connection with removal of waste from house cats.

The following examples are provided to illustrate the invention, but should not be construed as limiting the invention in scope.

### EXAMPLE 1

This Example illustrates the jet-cooking of ground, expeller-extracted spent corn germ, with and without odor-mitigating additives.

Expeller-extracted spent germ from a corn wet milling process was ground and sized through a 6 mesh screen and then jet-cooked at about 8% solids at 315-325° F. Steam in excess of that required to achieve 315-325° F. was supplied to the cooker via a combining tube, and back pressure in the cooker was set to 70 psig. Retention time in the cooker was 4.5 minutes.

As the jet-cooked slurry exited the back pressure valve of the cooker, excess steam was flashed off. One or more odor components from the germ were included with the flashed off steam. The washed product exiting the cooker was filtered using a C250 centrifuge. The dewatered solid material was dried in a jacketed ribbon blender.

This procedure was repeated in a series of runs in which amounts of six different additives were individually added to the original pre-cook slurry in an amount of 1% of the weight of expeller-extracted spent germ. The additives used, and the results of analyses of the products thus prepared, are set forth in the following table, TABLE 1.

TABLE 1

| | | | | | % | % | % |
|---|---|---|---|---|---|---|---|
| | | % | % Fat | % Starch | Protein | Solubles | Ash |
| RUN | Additive @ 1% | Solids | (dsb) | (dsb) | (dsb) | (dsb) | (dsb) |
| CONTROL | — | 97.69 | 8.0 | 17.56 | 24.81 | 4.13 | 2.8 |
| Expeller-extracted | | | | | | | |
| Wet-milled | | | | | | | |
| Spent Corn Germ | | | | | | | |
| 1A | None | 98.12 | 2.9 | 8.31 | 25.98 | 3.71 | 2.0 |
| 1B | Soap | 96.18 | 6.8 | 9.20 | 24.61 | 2.92 | 1.9 |
| 1C | Detergent | 91.93 | 3.1 | 9.90 | 23.44 | 3.78 | 2.0 |
| 1D | RHODAPEX | 92.92 | 8.6 | 8.80 | 23.50 | 3.28 | 1.9 |
| | EST-30¹ | | | | | | |
| 1E | Sodium | 97.01 | 3.8 | 10.40 | 25.99 | 2.80 | 2.1 |
| | Bicarbonate | | | | | | |
| 1F | Citric Acid | 88.98 | 8.8 | 9.50 | 23.20 | 4.61 | 2.0 |
| 1G | Sodium | 97.60 | 4.6 | 9.70 | 21.65 | 3.12 | 2.0 |
| | Hypochlorite | | | | | | |
| CONTROL | — | 90.62 | 1.1 | 40.24 | 15.35 | 3.94 | 3.3 |
| Solvent-extracted | | | | | | | |
| Dry-milled | | | | | | | |
| Spent Corn Germ | | | | | | | |

¹Ethoxylated Sodium Tridecyl Sulfate

### EXAMPLE 2

Nine different animal litters were made using a California Pellet Mill. The seven different jet cooked products described in Table 1 were used, and as controls, runs were made using solvent-extracted dry milled spent corn germ and using ground expeller-extracted spent germ from a corn wet milling process. The jet cooked spent germ products were used to make animal litters with the formula specified in Table 2. This formula was adapted from a formula described in U.S. Pat. No. 6,868,802. The animal litters were prepared in accordance with the procedures set forth in Example 1 and Example 2 of U.S. Pat. No. 6,098,569.

Generally, the germ, starch, and sodium chloride were blended simultaneously in a ratio of 78:20:2. The moisture was adjusted to 14.5% with the addition of water, and the resulting blend introduced into a California pellet mill. The temperature was adjusted to 82° C. by adding steam to the pellet mill. The mixture was extruded through a 3/32 inch×⅝ die at 100 lb/min to form pellets, which were them crumbled with a pellet crumbler to form discreet plural particles having a particle size capable of passing through an eight mesh screen but retained on a twenty mesh screen.

TABLE 2

| | |
|---|---|
| Salt | 2.0% |
| B-700 Corn Starch | 20.0% |
| Spent Corn Germ | 78.0% |

The litters were judged for odor, per se. The litters then were tested for uptake by introducing 30 ml water, delivered from a burette over a period of 2 minutes, and subsequently measuring the clump weight and appearance as reported in the table below. Ammonia odor masking was tested according to the procedure taught in U.S. Pat. No. 6,098,569.

Certain functional properties of the animal litters, including clumpability, clump weight, ammonia absorption, aroma, and screen distribution, were tested. Aroma evaluations were carried out by a panel of four evaluators. The four evaluators were employed by Grain Processing Corporation, the assignee of the present application. The evaluators have been trained to “pass” litters, the aromas of which match a standard animal litter formulation that had been accepted in consumer trials, and to “fail” litters the aromas which have been rejected in consumer trials. In blind trials, the four evaluators were asked “Is the aroma of the litter OK or NOT OK? Results of these analyses are presented in TABLE 3.

TABLE 3

| | | Litter Aroma | | Ammonia | Clump | |
|---|---|---|---|---|---|---|
| | | OK/NOT | Litter | Odor | Wt. @ | Clump Rating |
| Example | Additive @ 1% | OK | Color | Masking | 5 min | @ 5 min |
| Expeller-extracted | — | 0/4 OK | Brown | Offensive | 53 | Excellent |
| Wet-milled | | | | | | |
| Spent Corn Germ | | | | | | |
| 2A | None | 2/4 OK | Dark | Good | 51 | Excellent |
| | | | Brown | | | |
| 2B | Soap | 3/4 OK | Dark | Good | 60 | Excellent |
| | | | Brown | | | |
| 2C | Detergent | 3/4 OK | Dark | No | 60 | Excellent |
| | | | Brown | | | |
| 2D | RHODAPEX | 1/4 OK | Dark | No | 61 | Excellent/Fair |
| | EST-30 | | Brown | | | |
| 2E | Sodium | 3/4 OK | Dark | Slight | 54 | Excellent |
| | Bicarbonate | | Brown | Grain | | |
| 2F | Citric Acid | 1/4 OK | Dark | Slight | 66 | Excellent/Fair |
| | | | Brown | Grain | | |
| 2G | Sodium | 4/4 OK | Dark | Good | 59 | Excellent |
| | Hypochlorite | | Brown | | | |
| Solvent Extracted | — | 4/4 OK | Tan | Good | 60 | Excellent/Fair |
| Dry Milled Spent | | | | | | |
| Germ | | | | | | |

### EXAMPLE 3

This example illustrates the jet cooking of ground distiller's dried grains with solubles.

Distillers dried grains with solubles, obtained from a dry milled corn ethanol distillery, were ground and sized through a six mesh screen and then jet cooked at about eight percent solids at 350°-325° F. Steam in excess of that required to achieve the desired temperature was supplied to the cooker via a combining tube, and back pressure in the cooker was set to 70 psig. Retention time in the cooker was 4.5 minutes.

As the jet-cooked slurry exited the back pressure valve of the cooker, excess steam was flashed off. One or more odor components from the dried grains were included with the flashed off steam. The washed product exiting the cooker was filtered using a C250 centrifuge. The dewatered solid material was dried in a jacketed ribbon blender. The procedure was repeated in a second run in which sodium hypochlorite in the amount of one percent of the weight of the dried grains was added to the original pre-cooked slurry.

The products obtained were evaluated, and the results of the analysis set forth in Table 4 below. As controls, solvent-extracted dry-milled spent corn germ and unwashed distiller's dried grains with solubles also were analyzed.

TABLE 4
Distillers' Dried Grains with Solubles and JET-COOKED
Distillers' Dried Grains with Solubles

| | | | % | % | % | % |
|---|---|---|---|---|---|---|
| | % | % Fat | Starch | Protein | Solubles | Ash |
| Example | Solids | (dsb) | (dsb) | (dsb) | (dsb) | (dsb) |
| CONTROL | 92.4 | 14.1 | 5.6 | 26.5 | 16.7 | 4.3 |
| Distillers' Dried | | | | | | |
| Grains with | | | | | | |
| Solubles | | | | | | |
| CONTROL | 90.6 | 8.4 | 49.2 | 11.6 | 3.9 | 3.3 |
| Solvent-extracted | | | | | | |
| Dry-milled | | | | | | |
| Spent Corn Germ | | | | | | |
| 3A | 96.8 | 5.9 | 2.7 | 29.9 | 6.5 | 2.0 |
| JET-COOKED | | | | | | |
| Distillers' | | | | | | |
| dried Grains | | | | | | |
| with Solubles | | | | | | |
| 3B | 92.6 | 1.8 | 2.0 | 29.0 | 3.2 | 1.5 |
| JET-COOKED | | | | | | |
| Distillers' Dried | | | | | | |
| Grains with | | | | | | |
| Solubles + | | | | | | |
| 1% NaClO | | | | | | |

It is seen, by comparison of examples 3A and 3B with the first control, that the amount of fat, starch, and ash decreased upon washing and centrifugation. Without intending to limit the invention to a particular theory of operation, it is believed that fat, in the form of vegetable oil, was liberated upon the cooking and centrifugation of the grains. Ash and starch were believed to have solubilized and similarly to have been separated via centrifugation. The protein content increased on a dry solids basis percentage; it is believed that this is because of a decrease in mass of the grains via the loss of other components.

### EXAMPLE 4

Four different animal litters were made using a California pellet mill and the four products described in Table 4. The products were used to make animal litters in accordance with the formula specified in Table 5, which was adapted from a formula described in U.S. Pat. No. 6,868,802. The animal litters were prepared in accordance with Example 1 and Example 2 of U.S. Pat. No. 6,098,569, as summarized above. Extrusion was through a 3/32 inch×⅝ inch die. The litters were then tested and analyzed in accordance with the procedures set forth above in Example 2. The results of this analysis are set forth below in Table 6.

TABLE 5

| | |
|---|---|
| Salt | 2.0% |
| B-700 Corn Starch | 20.0% |
| Distillers' Dried Grains with Solubles from | 78.0% |
| a Dry Milled Corn Ethanol distillery | |

TABLE 6

| | Litter | | | | |
|---|---|---|---|---|---|
| | Aroma | | Ammonia | Clump | Clump |
| | OK/ | Litter | Odor | Wt. | Rating |
| Example | NOT OK | Color | Masking | @ 5 min | @ 5 min |
| CONTROL | 0/4 OK | Dark Tan | Good | 57 | Poor |
| Distillers' | | | | | |
| Dried | | | | | |
| Grains with | | | | | |
| Solubles | | | | | |
| CONTROL | 3/4 OK | Tan | Good | 62 | Excellent |
| Solvent- | | | | | |
| extracted | | | | | |
| Dry-milled | | | | | |
| Spent | | | | | |
| Corn Germ | | | | | |
| 3A | 3/4 OK | Dark Tan | Good | 54 | Excellent |
| 3B | 3/4 OK | Dark Tan | Good | 54 | Excellent |

Surprisingly, the jet-cooked, dewatered distiller's dried grains exhibited excellent clump rating, in comparison to the unwashed distiller's dried grains. Additionally, the aroma of the litter was substantially improved upon jet-cooking and dewatering.

### EXAMPLE 5

Animal litters having the following formulations are prepared. The washed, spent grain germ is wet-milled grain germ that has been washed in accordance with the procedures of Example 1A.

TABLE 7

| INGREDIENT | 5A | 5B |
|---|---|---|
| Starch | 10 | 12 |
| Washed, spent grain germ. | 25 | 26.25 |
| Citric Acid | 1 | 1 |
| Salt | 2 | 2 |
| Virgin germ | 5 | 3.75 |
| Ultra Fine Corn Bran | 15 | 0 |
| Citrus Peel Pellet Cattle Feed | 0 | 23 |
| Ground Corn | 41.9 | 31.85 |
| Potassium Sorbate | 0.1 | 0.15 |
| TOTAL | 100 | 100 |

In preferred embodiments, when the substrate is corn germ, the amount of water used to wash the germ may be relatively less than that ordinarily employed in conventional methods hereinbefore described. Nonetheless, it should be understood that the invention is not limited thereto. The invention is intended to encompass the subject matter defined by the following claims, irrespective of whether the amount of water actually used is greater or less than the amount of water used in connection with a prior washing method.

It is thus seen that the invention provides a method for washing a grain-based substrate in certain embodiments. In other embodiments, the invention provides an animal litter, a method for preparing an animal litter, and a method for removal of animal waste. In practice, in accordance with the preferred techniques described herein, the invention is operable to allow for washing of the grain-based substrate to a satisfactory level for use in an animal litter while using less water than the conventional washing technique described hereinabove.

All references, including publications, patent applications, and patents, cited herein are hereby incorporated by reference. In any listing of possible ingredients or components, mixtures of the possible ingredients or components are contemplated unless expressly indicated otherwise. The description of certain embodiments as “preferred” embodiments, and other recitation of embodiments, features, or ranges as being preferred, is not deemed to be limiting, and the invention is deemed to encompass embodiments that are presently deemed to be less preferred. All methods described herein can be performed in any suitable order unless otherwise indicated herein or otherwise clearly contradicted by context. The use of any and all examples, or exemplary language (e.g., “such as”) provided herein, is intended to illuminate the invention and does not pose a limitation on the scope of the invention unless otherwise claimed. Any statement herein as to the nature or benefits of the invention or of the preferred embodiments is not intended to be limiting, and the appended claims should not be deemed to be limited by such statements. More generally, no language in the specification should be construed as indicating any non-claimed element as being essential to the practice of the invention. This invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context. References to “a” or “one” or other expressions of a singular nature in the claims are intended to encompass the plural unless expressly indicated otherwise, irrespective of whether terminology such as “at least one” is used elsewhere.

1. A method of washing a grain-based substrate, comprising:
contacting said substrate with steam;
maintaining said grain-based substrate in contact with steam for a time and at a pressure sufficient to liberate at least a portion of at least one odor component from the substrate; and
separating at least a portion of said steam and at least some of the liberated odor component from the balance of the grain-based substrate thereby leaving a washed grain-based substrate.

2. A method according to claim 1, said grain-based substrate comprising spent grain germ.

3. A method according to claim 2, said grain germ comprising corn germ.

4. A method according to claim 1, the method including jet-cooking said grain-based substrate in a jet-cooking apparatus, said separating including flashing steam after said substrate has been maintained in contact with said steam.

5. A method according to claim 1, further comprising dewatering said grain-based substrate.

6. A method according to claim 1, comprising including an odor-mitigating additive with said steam.

7. A method according to claim 6, said odor-mitigating additive being added in an amount of 0.1% to 10% by dry basis weight of said grain-based substrate.

8. A method according to claim 6, said additive comprising one or more of a soap, a detergent, and an oxidizing agent.

9. A method for preparing an animal litter, comprising:
providing a washed, spent grain germ, said grain germ having been washed by contacting said grain germ with steam and maintaining said grain germ in contact with said steam for a time and at a pressure sufficient to liberate at least a portion of one odor component, and separating at least a portion of said steam and at least some of said liberated odor component from the balance of said grain germ to leave a washed grain germ, an odor-mitigating additive having been included with said steam; and
forming discrete plural compacted particles comprising said grain germ.

10. A method according to claim 9, said particles being formed in a pellet mill.

11. A method according to claim 9, further comprising incorporating a cohesiveness agent into said particles.

12. A method according to claim 11, further comprising incorporating a supplemental cohesiveness agent into said particles.

13. An animal litter comprising a washed, spent grain germ, said washed, spent grain germ having been washed by contacting said grain germ with steam and maintaining said grain germ in contact with said steam for a time and at a pressure sufficient to liberate at least a portion of one odor component, and separating at least a portion of said steam and at least some of the said liberated odor component from the balance of said grain germ to leave a washed grain germ, an odor-mitigating additive having been included with said steam, said animal litter being in the form of discrete plural compacted particles.

14. An animal litter according to claim 13, said animal litter comprising a cohesiveness agent.

15. An animal litter according to claim 14, comprising a supplemental cohesiveness agent.

16. A method for preparing an animal litter, comprising:
providing a grain-based substrate, said grain germ having been washed by contacting said grain germ with steam and maintaining said grain germ in contact with said steam for a time and at a pressure sufficient to liberate at least a portion of one odor component, and separating at least a portion of said steam and at least some of the said liberated odor component from the balance of said grain germ to leave a washed grain germ, an odor-mitigating additive having been included with said steam; and
forming discrete plural compacted particles comprising said grain germ.

17. A method according to claim 16, said particles being formed in a pellet mill.

18. A method according to claim 16, further comprising incorporating a cohesiveness agent into said particles.

19. A method according to claim 18, further comprising incorporating a supplemental cohesiveness agent into said particles.

20. A method for washing a grain-based substrate, comprising:
contacting said substrate with steam;
maintaining said grain-based substrate in contact with steam for a time of at least one minute and at positive gauge pressure, whereby at least a portion of one odor component is liberated from the substrate; and
separating at least a portion of said steam and at least some of the liberated odor component from the balance of the grain-based substrate thereby leaving a washed grain-based substrate.

21. A method according to claim 20, said grain-based substrate being a liquid-absorbent portion of a grain.

22. A method according to claim 20, comprising including an odor-mitigating additive with said steam.

23. A method of washing distiller's dried grain, comprising:
contacting said distiller's dried grain with steam;
maintaining said distiller's dried grain in contact with steam for a time and at a pressure sufficient to liberate at least a portion of one odor component from the substrate;
separating at least a portion of said steam and at least some of the liberated odor component from the balance of the distiller's dried grain; and
dewatering said distiller's dried grain thereby leaving a washed, dewatered substrate.

24. A method according to claim 23, the method including, jet-cooking said distiller's dried grain in a jet-cooking apparatus, said separating including flashing steam after said distiller's dried grain has been maintained in contact with steam.

25. A method according to claim 24, comprising including an odor-mitigating additive with said steam.

26. A method according to claim 25, said odor-mitigating additive being added in an amount of 0.1% to 10% by dry basis weight of said grain-based substrate.

27. A method according to claim 25, said additive comprising one or more of a soap, a detergent, and an oxidizing agent.

28. A method according to claim 23, said dewatering comprising centrifugation.

29. A method for preparing an animal litter, comprising:
providing a substrate, said substrate comprising a distiller's dried grain substrate that has been washed by contacting distiller's dried grain with steam and maintaining said distiller's dried grain in contact with steam for a time and at a pressure sufficient to liberate at least a portion of one odor component, separating at least a portion of said steam and at least some of said liberated odor component from the balance of said distiller's dried grain to leave a washed distiller's dried grain, and dewatering said washed distiller's dried grain to leave a substrate; and
forming discrete plural compacted particles comprising said substrate.

30. The method according to claim 29, said particles being formed in a pellet mill.

31. A method according to claim 29, further comprising incorporating a cohesiveness agent into said particles.

32. A method according to claim 31, further comprising incorporating a supplemental cohesiveness agent into said particles.

33. A method according to claim 29, an odor mitigating additive having been included with said steam.

34. An animal litter comprising a substrate, said substrate comprising:
a distiller's dried grain substrate that has been washed by contacting distiller's dried grain with steam and maintaining said distiller's dried grain in contact with steam for a time and at a pressure sufficient to liberate at least a portion of one odor component, separating at least a portion of said steam and at least some of said liberated odor component from the balance of said distiller's dried grain to leave a washed distiller's dried grain, and dewatering said washed distiller's dried grain to leave a substrate, said animal litter being in the form of discrete plural contacted particles.

35. An animal litter according to claim 34, said animal litter comprising a cohesiveness agent.

36. An animal litter according to claim 35 comprising a supplemental cohesiveness agent.

37. An animal litter according to claim 34, an odor mitigating additive having been included with said steam.
